(19) United States
(12) Patent Application Publication
(10) Pub. No.: US 2021/0350077 A1
(43) Pub. Date: Nov. 11, 2021

(54) COMPUTER-IMPLEMENTED METHOD FOR CONCEPT EXTRACTION

(71) Applicant: Robert Bosch GmbH, Stuttgart (DE)

(72) Inventors: Lukas Lange, Pforzheim (DE); Heike Adel-Vu, Stuttgart (DE); Jannik Stroetgen, Karlsruhe (DE)

(21) Appl. No.: 17/306,530

(22) Filed: May 3, 2021

(30) Foreign Application Priority Data
May 7, 2020 (DE) 102020205776.1

(51) Int. Cl. G06F 40/279; G06N 3/04; G06N 3/08; G06F 40/166

(52) U.S. Cl. CPC G06F 40/279; G06F 40/166; G06N 3/08; G06N 3/0445

(57) ABSTRACT

A computer-implemented method. The method includes: providing input data for a model; anonymizing at least a portion of the input data, the anonymizing including the provision of masked embeddings of the input data, and extracting pieces of information from the masked embeddings. The steps for anonymizing at least a portion of the input data and for extracting pieces of information are carried out using a hierarchical model.

### CROSS REFERENCE

The present application claims the benefit under 35 U.S.C. § 119 of German Patent Application No. DE 102020205776.1 filed on May 7, 2020, which is expressly incorporated herein by reference in its entirety.

### FIELD

The present invention relates to a computer-implemented method for concept extraction in the field of anonymized data.

The present invention furthermore relates to a device and a computer program for carrying out the computer-implemented method and a method for training a model for use in the computer-implemented method for concept extraction in the field of anonymized data.

### BACKGROUND INFORMATION

In the field of knowledge extraction, in particular extraction of pieces of information and/or extraction of concepts, relationships are to be recognized from a large set of data, in particular automatically. One application is, for example, the medical domain, certain concepts, for example active ingredients and medications, being extracted from data. The data typically also include sensitive, in particular personal, data. The extraction of pieces of information and/or the extraction of concepts is therefore typically carried out on previously anonymized data.

Conventional methods consider the two tasks separately, i.e., using models independent of one another.

### SUMMARY

One specific embodiment of the present invention relates to a computer-implemented method including the following steps:

providing input data for a model;

anonymizing at least a portion of the input data, the anonymizing including the provision of masked embeddings of the input data, and extracting pieces of information from the masked embeddings.

The method handles the anonymizing and extraction tasks in a shared hierarchical model.

In the conventional methods, the extraction model is trained on non-anonymized data and then applied to anonymized data. This procedure does not take into consideration in the training that in an actual application, anonymizing is carried out first and then the anonymized data are further processed, in particular concepts are extracted. For the conventional model that extracts the concepts this means that it is applied to data having entirely different structures, namely anonymized data, than it was trained on, namely non-anonymized data. This may result in a reduction of the performance of the model.

The method in accordance with an example embodiment of the present invention overcomes these disadvantages by handling the anonymizing and extraction tasks in a shared hierarchical model.

Preferably, an output which includes the extracted pieces of information is output at an outlet of the model.

According to one preferred specific embodiment of the present invention, the step of anonymizing at least a portion of the input data furthermore includes: classifying the input data. It is preferably indicated by the classification for elements of the input data whether a particular element is to be anonymized.

The elements to be anonymized are, for example, sensitive elements which are to be protected.

According to one preferred specific embodiment of the present invention, the step of anonymizing at least a portion of the input data furthermore includes: replacing at least a portion of the input data as a function of the classification by a masked embedding. A class which characterizes whether and/or by which masked embedding the element is to be replaced is advantageously determined by the classification for a particular element. It is ensured by replacing at least a portion of the input data that the step of extracting pieces of information from the masked embeddings does not have access to the elements of the input data to be anonymized.

According to one preferred specific embodiment of the present invention, the step of anonymizing at least a portion of the input data furthermore includes: approximating the classified input data by way of a continuous distribution, in particular by way of a Gumbel-Softmax distribution. It is thus ensured that the classified input data are provided as discrete values to the step of replacing at least part of the input data by masked embeddings. The differentiability of the model is ensured in this way.

The Gumbel-Softmax distribution is described, for example, in Chris J. Maddison, Andriy Mnih, and Yee Whye Teh. 2017, “The concrete distribution: A continuous relaxation of discrete random variables,” in International Conference on Learning Representations.

According to one preferred specific embodiment of the present invention, the input data of the model are defined by embeddings of a text body. The text body is, for example, a text collection or a document collection. Starting from the text body, embeddings for individual words or sentences are generated, for example, as word vectors.

According to one preferred specific embodiment of the present invention, the extraction of pieces of information from the masked embeddings includes the classification of the masked embeddings. The masked embeddings are classified, for example, as associated with a class, in particular a concept class, or as not associated with a class, in particular a concept class.

According to one preferred specific embodiment of the present invention, the classification of the input data and/or the classification of the masked embeddings is modeled as a sequence tagging task.

According to one preferred specific embodiment of the present invention, the model includes at least one recurrent neural network. This model is particularly suitable for classifying and/or extracting pieces of information, in particular concepts.

Further preferred specific embodiments of the present invention relate to a device, the device being designed to carry out a method according to the specific embodiments.

According to one preferred specific embodiment of the present invention, the device includes at least one memory unit for a model, in particular a recurrent neural network, the model in particular including a layer for classifying at least one part of the input data, a layer for approximating the classified input data by way of a continuous distribution, a layer for replacing at least a portion of the input data with masked embeddings as a function of the classification, and a layer for extracting pieces of information from the masked embeddings, in particular by classifying the masked embeddings.

Further preferred specific embodiments of the present invention relate to a computer program, the computer program including machine-readable instructions, which carry out a computer-implemented method according to the specific embodiments when they are executed on a computer, in particular a processing unit of a device according to the specific embodiments.

Further preferred specific embodiments of the present invention relate to a method for training a model for use in a computer-implemented method according to the specific embodiments and/or in a device according to the specific embodiments, the method for training the model including: pretraining the model to anonymize the input data and training the model to anonymize the input data and to extract pieces of information on anonymized input data, during the training for extracting pieces of information, in particular randomly initialized masked embeddings also being trained, which replace at least a portion of the input data.

Due to the combination of the two tasks, namely the anonymizing and the extraction of pieces of information in one model, a robust model may be learned for both tasks. Moreover, the training for extracting pieces of information is already trained on anonymized input data.

The training data advantageously include non-anonymized data, at least a portion of the training data being labeled with pieces of anonymizing information and at least a portion of the training data being labeled with pieces of information extraction information. The training data labeled with pieces of anonymizing information may overlap with the training data labeled with pieces of information extraction information.

Further preferred specific embodiments of the present invention relate to the application of the method for the automatic extraction of knowledge from data, which contain sensitive, in particular private data, in particular medical data, and therefore have to be anonymized. The method is also applicable to other domains outside medicine.

Further features, possible applications, and advantages of the present invention result from the following description of exemplary embodiments of the present invention which are shown in the figures. All features described or shown form the subject matter of the present invention as such or in any arbitrary combination, regardless of their wording or depiction in the description or in the figures.

### BRIEF DESCRIPTION OF THE DRAWINGS

FIG. 1 shows a schematic representation of steps of a computer-implemented method in a flow chart, in accordance with an example embodiment of the present invention.

FIG. 2 shows a schematic representation of a model for a computer-implemented method of FIG. 1, in accordance with an example embodiment of the present invention.

FIG. 3 shows a schematic representation of a device for carrying out a computer-implemented method of FIG. 1, in accordance with an example embodiment of the present invention.

### DETAILED DESCRIPTION OF EXAMPLE EMBODIMENTS

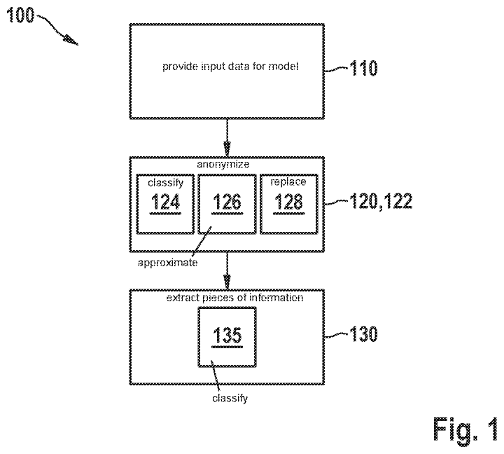

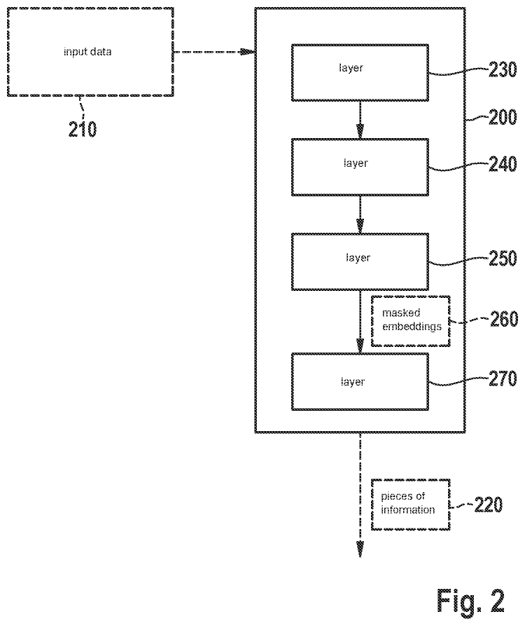

FIG. 1 shows a schematic representation of steps of a computer-implemented method 100. According to one specific embodiment of the present invention, method 100 includes the use of a model 200. A specific embodiment of model 200 in accordance with the present invention is shown in FIG. 2 and described with reference to FIG. 2.

Computer-implemented method 100 includes

a step 110 for providing input data 210 for model 200;

a step 120 for anonymizing at least a portion of input data 210, step 120 for anonymizing at least a portion of input data 210 including providing 122 masked embeddings 260 of input data 210, and

a step 130 for extracting pieces of information 220 from the masked embeddings.

According to one specific embodiment of the present invention, step 120 for anonymizing at least a portion of input data 210 includes a step for classifying 124 input data 210.

According to one specific embodiment of the present invention, step 120 for anonymizing at least a portion of input data 210 includes a step for approximating 126 classified input data 210 by way of a continuous distribution, in particular a Gumbel-Softmax distribution. It is thus ensured that classified input data 210 are provided as discrete values to a step 128 for replacing at least a portion of input data 210 with masked embeddings 260. The differentiability of model 200 is ensured in this way.

The Gumbel-Softmax distribution is described, for example in Chris J. Maddison, Andriy Mnih, and Yee Whye Teh. 2017, “The concrete distribution: A continuous relaxation of discrete random variables,” in International Conference on Learning Representations.

According to one specific embodiment of the present invention, step 120 for anonymizing at least a portion of input data 210 includes a step for replacing 128 at least a portion of input data 210 as a function of classifying 124 by masked embeddings 260.

According to one specific embodiment, step 130 for extracting pieces of information 220 includes classifying 135 masked embeddings 260.

According to one specific embodiment, classifying 124 input data 210 and/or classifying 135 masked embeddings 260 is modeled as a sequence tagging task.

According to one specific embodiment, model 200 includes at least one recurrent neural network.

Input data 210 of model 200 are, for example, embeddings of a text body. The text body is, for example, a text collection or a document collection. Starting from the text body, the embeddings for individual words or sentences are generated, for example, as word vectors.

In a layer 230 of model 200, input data 210, in particular at least a portion of the input data, are classified 124. Classifying 124 may be modeled as a sequence tagging task. Layer 230 is constructed, for example, according to a BiLSTM architecture, bidirectional long short-term memory.

The BiLSTM architecture is described, for example, in Sepp Hochreiter and Jürgen Schmidhuber, 1997, “Long short-term memory,” Neural Comput., 9(8):1735-1780.

Furthermore, step 230 includes, for example, a CRF, conditional random field, output layer. Further pieces of information in this regard are described in

John D. Lafferty, Andrew McCallum, and Fernando C. N. Pereira, 2001, “Conditional random fields: Probabilistic models for segmenting and labeling sequence data,” in Proceedings of the Eighteenth International Conference on Machine Learning, ICML'01, pages 282-289, San Francisco, Calif., USA. Morgan Kaufmann Publishers Inc, and in

Guillaume Lample, Miguel Ballesteros, Sandeep Subramanian, Kazuya Kawakami, and Chris Dyer, 2016, “Neural architectures for named entity recognition,” in Proceedings of the 2016 Conference of the North American Chapter of the Association for Computational Linguistics: Human Language Technologies, pages 260-270, San Diego, Calif. Association for Computational Linguistics.

In a layer 240 of model 200, the classified input data are approximated 128 by a continuous distribution, in particular a Gumbel-Softmax distribution.

In a layer 250 of model 200, at least a portion of input data 210 are replaced 128 as a function of classifying 124 by masked embeddings 260. It is ensured by preceding layer 240 that input data 210 are provided to layer 250 in a discrete form.

Layer 250 for replacing 128 input data 210 by masked embeddings 260 ensures that subsequent layers of models 200 do not have access to pieces of data-protection-sensitive information.

In a layer 270 of model 200, pieces of information 220 are extracted 130 from masked embeddings 260, in particular by classifying 135 the masked embeddings. Layer 270 is preferably constructed like layer 230.

It is ensured by the described structure of model 200 that only layers 230, 240, 250 for anonymizing 120 input data 210 have access to all input data 210 in a non-anonymized form and thus possibly access to pieces of sensitive information. The input in layer 270 for extracting 130 information 220 from masked embeddings 260 is restricted by masked embeddings 260.

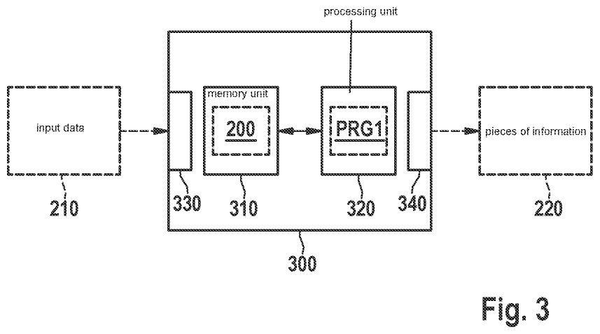

Further preferred specific embodiments of the present invention relate to a device 300, which is designed to carry out a method 100 according to the described specific embodiments. The device is shown in FIG. 3.

According to the specific embodiment of the present invention, device 300 includes at least one memory unit 310 for model 200 according to the described specific embodiments. Device 300 includes a processing unit 320, a method 100 according to the specific embodiments being carried out by executing a computer program PRG1 on processing unit 320. Furthermore, the device includes an interface 330, via which input data 210 are provided. Moreover, device 300 includes an interface 340, via which extracted pieces of information 220 are output.

Further preferred specific embodiments of the present invention relate to a method for training model 200 for use in a computer-implemented method 100 according to the specific embodiments and/or in a device 300 according to the specific embodiments. The method for training model 200 includes: pre-training model 200 for anonymizing 120 input data 210 and training model 200 for anonymizing 120 input data 210 and for extracting 130 pieces of information 220 on anonymized input data, during the training for extracting 130 pieces of information 220, masked embeddings 260, which are in particular randomly initialized, also being trained, which replace at least a portion of input data 210.

Model 200 is trained robustly for both tasks by the combination of the two tasks, namely anonymizing 120 and extracting 130 pieces of information 220, in model 200.

Moreover, the model for extracting 130 pieces of information 220 is already trained on anonymized input data.

Further preferred specific embodiments of the present invention relate to the use of method 100 for the automatic extraction of knowledge from data which contain sensitive, in particular private, data, in particular medical data, and therefore have to be anonymized. Method 100 is also applicable to other domains outside medicine.

What is claimed is:

1. A computer-implemented method, comprising the following steps:
providing input data for a model;
anonymizing at least a portion of the input data, the anonymizing including providing masked embeddings of the input data, and extracting pieces of information from the masked embeddings.

2. The computer-implemented method as recited in claim 1, wherein the step of anonymizing at least a portion of the input data of the model further includes classifying the input data.

3. The computer-implemented method as recited in claim 1, wherein the step of anonymizing at least a portion of the input data of the model further includes approximating the classified input data using a continuous distribution, the continuous distribution being a Gumbel-Softmax distribution.

4. The computer-implemented method as recited in claim 1, wherein the step of anonymizing at least a portion of the input data of the model further includes replacing at least a portion of the input data as a function of classifying by masked embeddings.

5. The computer-implemented method as recited in claim 1, wherein the input data of the model are defined by embeddings of a text body.

6. The computer-implemented method as recited in claim 2, wherein the extraction of pieces of information from the masked embeddings includes classifying the masked embeddings.

7. The computer-implemented method as recited in claim 6, wherein the classifying of the input data and/or the classifying of the masked embeddings is modeled as a sequence tagging task.

8. The computer-implemented method as recited in claim 1, wherein the model includes at least one recurrent neural network.

9. A device configured to:
provide input data for a model; and
anonymize at least a portion of the input data, the anonymizing including provision of masked embeddings of the input data, and extraction of pieces of information from the masked embeddings.

10. The device as recited in claim 9, wherein the device includes at least one memory unit for the model, the model including a recurrent neural network, the model including a layer configured to classify at least a portion of the input data, a layer configured to approximate the classified input data by way of a continuous distribution, a layer configured to replace at least a portion of the input data as a function of classifying by masked embeddings, and a layer configured to extract pieces of information from the masked embeddings by classifying the masked embeddings.

11. A non-transitory machine-readable storage medium on which is stored a computer program including machine-readable instructions, the instructions, when executed by a computer, causing the computer to perform the following steps:
providing input data for a model;
anonymizing at least a portion of the input data, the anonymizing including providing masked embeddings of the input data, and extracting pieces of information from the masked embeddings.

12. A method for training a model, comprising:
pretraining the model for anonymizing input data; and
training the model for anonymizing input data and for extracting pieces of information on the anonymized input data, during the training for extracting pieces of information, masked embeddings, which are randomly initialized, also being trained, which replace at least a portion of the input data.

13. The method for training the model as recited in claim 12, wherein training data for training the model include non-anonymized data, at least a portion of the training data being labeled with pieces of anonymizing information and at least a portion of the training data being labeled with pieces of information extraction information.
